(19) United States
(12) Patent Application Publication
(10) Pub. No.: US 2026/0303150 A1
(43) Pub. Date: Oct. 1, 2026

(54) METHOD AND APPARATUS FOR DEALING WITH CONCURRENT TRIGGER-BASED BLOCK ACKNOWLEDGEMENTS USED IN COORDINATED BEAMFORMING FRAME EXCHANGE SEQUENCE

(71) Applicant: MEDIATEK INC., Hsinchu City (TW)

(72) Inventors: Pochun Fang, Hsinchu City (TW); You-Wei Chen, San Jose, CA (US)

(73) Assignee: MEDIATEK INC., Hsinchu City (TW)

(21) Appl. No.: 19/578,839

(22) Filed: Mar. 25, 2026

Related U.S. Application Data
(60) Provisional application No. 63/778,470, filed on Mar. 27, 2025.

(51) Int. Cl. H04B 7/024; H04B 7/06; H04L 5/00

(52) U.S. Cl. CPC H04B 7/024; H04B 7/0617; H04L 5/0051

(57) ABSTRACT

A wireless communication method includes: performing a coordinated beamforming (Co-BF) transmission to transmit a first physical layer protocol data unit (PPDU) to a first non-access point (non-AP) station (STA) associated with a first access point (AP); and receiving a first block ack (BA) frame in a trigger-based (TB) format from the first non-AP STA, wherein the first BA frame carries information indicative of acknowledgement of the first PPDU; a period in which the first BA frame is transmitted overlaps a period in which a second BA frame is transmitted, where the second BA frame carries information indicative of acknowledgement of a second PPDU transmitted to a second non-AP STA associated with a second AP; and the first AP and the second AP include a Co-BF coordinating AP and a Co-BF coordinated AP.

### CROSS REFERENCE TO RELATED APPLICATIONS

This application claims the benefit of U.S. Provisional Application No. 63/778,470, filed on Mar. 27, 2025. The content of the application is incorporated herein by reference.

### BACKGROUND

The present disclosure relates to wireless communications, and more particularly, to a method and apparatus for dealing with concurrent trigger-based block acknowledgments used in a coordinated beamforming (Co-BF) frame exchange sequence.

Wireless local area network (WLAN) is a network that uses wireless communication technology (e.g., Wi-Fi technology) to transmit/receive data within a limited range. Hence, a WLAN system may include a plurality of WLAN devices such as Wi-Fi devices including at least one access point (AP) and at least one non-AP station (STA). With development of the Wi-Fi technology, multi-AP coordination (MAPC) is proposed for managing multiple APs to avoid interference and ensure efficient communications between client devices and the network. One of the MACP schemes is Co-BF. The objective of Co-BF is to allow more efficient medium usage by enabling concurrent transmissions of two APs to non-AP STAs associated with the two APs respectively, whereby each AP transmits to its associated non-AP STA(s) within its basic service set (BSS) while minimizing interference to the non-AP STA(s) associated with the other AP by using the channel state information (CSI) of the channels between each AP and the recipient non-AP STAs of the other AP of the Co-BF transmission. After an AP performs Co-BF transmission to transmit one downlink (DL) physical layer protocol data unit (PPDU) to its associated non-AP STA, the associated non-AP STA is requested to respond with a block ack (BA) frame for confirming successful receipt of the DL PPDU. How to efficiently transmit BS frames from non-AP STAs to APs during the Co-BF frame exchange sequence becomes an issue to be addressed.

### SUMMARY

One of the objectives of the claimed invention is to provide a method and apparatus for dealing with concurrent trigger-based block acknowledgments used in a Co-BF frame exchange sequence.

According to a first aspect of the present invention, an exemplary wireless communication method is disclosed. The exemplary wireless communication method includes: performing a Co-BF transmission to transmit a first PPDU to a first non-AP STA associated with a first AP; and receiving a first BA frame in a trigger-based (TB) format from the first non-AP STA, wherein the first BA frame carries information indicative of acknowledgement of the first PPDU; a period in which the first BA frame is transmitted overlaps a period in which a second BA frame is transmitted, where the second BA frame carries information indicative of acknowledgement of a second PPDU transmitted to a second non-AP STA associated with a second AP; and the first AP and the second AP include a Co-BF coordinating AP and a Co-BF coordinated AP.

According to a second aspect of the present invention, an exemplary wireless communication method is disclosed. The exemplary wireless communication method includes: receiving a first PPDU from a first AP that performs a Co-BF transmission to a first non-AP STA associated with the first AP; and transmitting a first BA frame in a TB format to the first AP, wherein the first BA frame carries information indicative of acknowledgement of the first PPDU; a period in which the first BA frame is transmitted overlaps a period in which a second BA frame is transmitted, where the second BA frame carries information indicative of acknowledgement of a second PPDU transmitted to a second non-AP STA associated with a second AP; and the first AP and the second AP include a Co-BF coordinating AP and a Co-BF coordinated AP.

According to a third aspect of the present invention, an exemplary AP is disclosed. The exemplary AP includes a network interface circuit and a control circuit. The control circuit is configured to instruct the network interface circuit to: perform a Co-BF transmission to transmit a first PPDU to a first non-AP STA associated with the AP; and receive a first BA frame in a TB format from the first non-AP STA. The first BA frame carries information indicative of acknowledgement of the first PPDU. A period in which the first BA frame is transmitted overlaps a period in which a second BA frame is transmitted, where the second BA frame carries information indicative of acknowledgement of a second PPDU transmitted to a second non-AP STA associated with another AP. The AP and the another AP include a Co-BF coordinating AP and a Co-BF coordinated AP.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first Co-BF frame exchange sequence with concurrent trigger-based block acknowledgments according to an embodiment of the present invention.

FIG. 2 is a diagram illustrating a second Co-BF frame exchange sequence with concurrent trigger-based block acknowledgments according to an embodiment of the present invention.

FIG. 3 is a diagram illustrating a third Co-BF frame exchange sequence with concurrent trigger-based block acknowledgments according to an embodiment of the present invention.

FIG. 4 is a diagram illustrating a fourth Co-BF frame exchange sequence with concurrent trigger-based block acknowledgments according to an embodiment of the present invention.

FIG. 5 is a diagram illustrating a wireless communication device according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

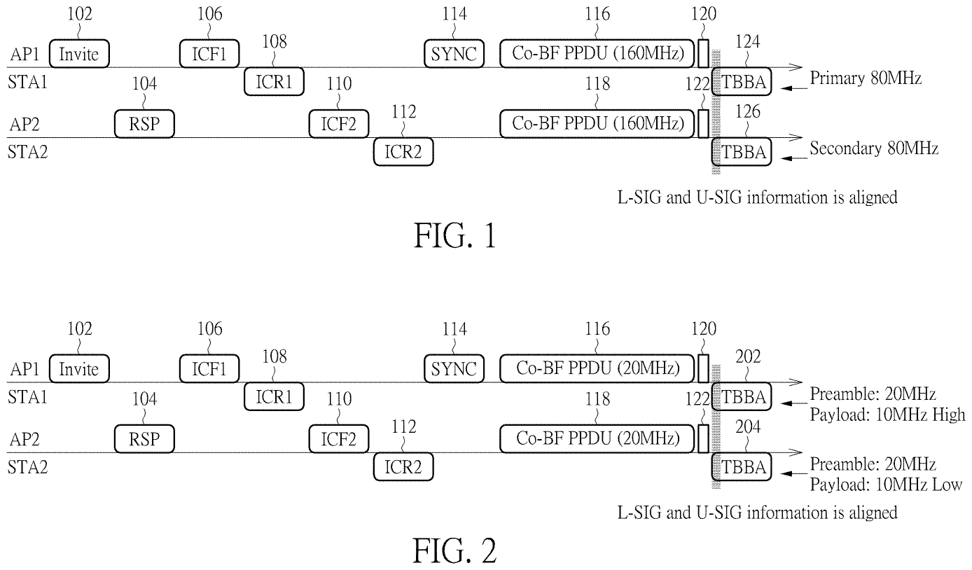

FIG. 1 is a diagram illustrating a first Co-BF frame exchange sequence with concurrent trigger-based block acknowledgments according to an embodiment of the present invention. A sharing AP is a transmission opportunity (TXOP) owner that wants to share its TXOP with a shared AP. In this embodiment, the MAPC scheme is Co-BF, the sharing AP acts as a Co-BF coordinating AP (which is denoted by “AP1”), and the shared AP acts as a Co-BF coordinated AP (which is denoted by “AP2”). One or more non-AP STAs may be associated with AP1, and one or more non-AP STAs may be associated with AP2. For better comprehension of technical features of the present invention, the following assumes that one non-AP STA (denoted by “STA1”) associated with AP1 is scheduled for Co-BF transmission during the current TXOP owned by AP1, and one non-AP STA (denoted by “STA2”) associated with AP2 is scheduled for Co-BF transmission during the current TXOP owned by AP1. However, this is for illustrative purposes only, and is not meant to be a limitation of the present invention.

As shown in FIG. 1, AP1 initiates the Co-BF frame exchange sequence by transmitting a Co-BF Invite frame (labeled by “Invite”) 102 to AP2. After receiving the Co-BF Invite frame 102, AP2 transmits a Co-BF Response frame (labeled by “RSP”) 104 to AP1, where the Co-BF Response frame 104 indicates whether the Co-BF invitation from AP1 is accepted or rejected by AP2. In this embodiment, the Co-BF invitation from AP1 is accepted by AP2.

If STA1 associated with AP1 is an enhanced multi-link single-radio (EMLSR) STA or a dynamic power save (DPS) STA, AP1 transmits an initial control frame (labeled by “ICF1”) 106 to STA1, and STA1 transmits an initial control response (labeled by “ICR1”) 108 to AP1. If STA2 associated with AP2 is an EMLSR STA or a DPS STA, AP2 transmits an initial control frame (labeled by “ICF2”) 108 to STA2, and STA2 transmits an initial control response (labeled by “ICR2”) 110 to AP2. In other words, ICF and ICR exchanges may be needed to support EMLSR/DPS STAs.

AP1 transmits a Co-BF trigger frame (labeled by “SYNC”) 114 to AP2 prior to Co-BF transmission of DL PPDUs. The Co-BF trigger frame 114 acts as a synchronization frame, and provides needed parameters for joint transmission.

In this embodiment, it is assumed that the operating bandwidth of AP1 is 160 MHz, and the operating bandwidth of AP2 is also 160 MHz. AP1 performs Co-BF transmission to transmit a DL PPDU 116 to STA1. AP2 performs Co-BF transmission to transmit a DL PPDU 118 to STA2. Specifically, two DL PPDUs 116 and 118 are transmitted simultaneously by AP1 and AP2.

After the end of the DL PPDU 116, AP1 transmits a standalone trigger frame 120 to STA1 to solicit a BA frame (labeled by “TBBA”) 124 in a TB format. That is, the standalone trigger frame 120 includes TB PPDU format indication signaling. Hence, the BA frame 124 solicited by the standalone trigger frame 120 is carried by a first TB PPDU transmitted from STA1 to AP1. The BA frame 124 carries information indicative of acknowledgement of the DL PPDU 116. For example, the standalone trigger frame 120 may be a multi-user block ack request (MU-BAR) frame. The MU-BAR frame can be sent with High Efficiency (HE)/Extreme High Throughput (EHT)/Ultra-High Reliability (UHR) rate to apply beamform nulling.

Similarly, after the end of the DL PPDU 118, AP2 transmits a standalone trigger frame 122 to STA2 to solicit a BA frame (labeled by “TBBA”) 126 in a TB format. That is, the standalone trigger frame 122 includes TB PPDU format indication signaling. Hence, the BA frame 126 solicited by the standalone trigger frame 122 is carried by a second TB PPDU transmitted from STA2 to AP2. The BA frame 126 carries information indicative of acknowledgement of the DL PPDU 118. For example, the standalone trigger frame 123 may be an MU-BAR frame. The MU-BAR frame can be sent with HE/EHT/UHR rate to apply beamform nulling.

A period in which the BA frame 124 is transmitted may fully/partially overlap a period in which the BA frame 126 is transmitted. In this embodiment, concurrent trigger-based block acknowledgements are used by the proposed Co-BF frame exchange sequence. Since STA1 and STA2 are triggered to currently respond with BA frames 124 and 126, transmission overhead resulting from transmitting BA frames in non-overlapping periods can be greatly reduced.

The BA frame 124 is contained in a payload of the first TB PPDU transmitted from STA1 to AP1. The BA frame 126 is contained in a payload of the second TB PPDU transmitted from STA2 to AP2. In this embodiment, signal (SIG) information contained in a preamble of the first TB PPDU (which carries BA frame 124) is aligned with SIG information contained in a preamble of the second TB PPDU (which carries BA frame 126). In other words, information recorded in all SIG fields (e.g., legacy SIG (L-SIG) field and universal SIG (U-SIG) field) in the preamble of the first TB PPDU (which carries BA frame 124) is the same as information recorded in all SIG fields (e.g., L-SIG field and U-SIG field) in the preamble of the second TB PPDU (which carries BA frame 126). For example, a BSS Color field included a U-SIG field of any of TB PPDUs used to carry BA frames 124 and 126 may carry AP1's BSS color, may carry AP2's BSS color, or may be set to 0 (i.e., BSS Color=0).

In a first exemplary SIG alignment design, SIG information aligned in two TB PPDUs used to carry BA frames 124 and 126 is solely decided by the Co-BF coordinating AP (i.e., AP1). For example, Co-BF trigger frame 114 transmitted by AP1 can be used to convey the SIG information used to construct a common preamble of two TB PPDUs used to carry BA frames 124 and 126. In addition to L-SIG content and all U-SIG-1 and U-SIG-2 content (e.g., with PPDU sending on BW160, indicate AP1 to trigger STA1 with RU 134 and indicate AP2 to trigger STA2 with RU 135; TXOP value can be aligned based on AP1 and AP2 Tx PPDU's remaining network allocation vector (NAV); BSS color can carry 0; and Spatial Reuse 1 and Spatial Reuse 2 can carry 0×F or 0×0 to block preferred spatial reuse (PSR)), the Co-BF trigger frame 114 can carry information needed to achieve trigger frame Common Info alignment on AP1 and AP2.

In a second exemplary SIG alignment design, SIG information aligned in two TB PPDUs used to carry BA frames 124 and 126 is negotiated between AP1 and AP2 before DL PPDUs 116 and 118 are transmitted.

The BA frame 124 is contained in a payload of the first TB PPDU transmitted from STA1 to AP1. The BA frame 126 is contained in a payload of the second TB PPDU transmitted from STA2 to AP2. Regarding the embodiment shown in FIG. 1, the preamble and the payload of the first TB PPDU are located on non-overlapping resource units (RUs) within the 160 MHz bandwidth of AP1 and AP2, and the preamble and the payload of the second TB PPDU are located on non-overlapping RUs within the 160 MHz bandwidth of AP1 and AP2. For example, the first TB PPDU (which carries BA frame 124) is transmitted on a primary 80 MHz channel, and the second TB PPDU (which carries BA frame 126) is transmitted on a secondary 80 MHz channel. It should be noted that a Co-BF device may switch its Primary Preamble Detect channel to a target response primary 20 MHz channel location for signal reception.

The preamble of the first TB PPDU (which carries BA frame 124) is located on RUs not occupied by the preamble of the second TB PPDU (which carries BA frame 126), and the payload of the first TB PPDU (which carries BA frame 124) is located on RUs not occupied by the payload of the second TB PPDU (which carries BA frame 126). However, this is for illustrative purposes only, and is not meant to be a limitation of the present invention. Since two TB PPDUs for carrying BA frames may have the same preamble, the preamble can be located on overlapping RUs.

FIG. 2 is a diagram illustrating a second Co-BF frame exchange sequence with concurrent trigger-based block acknowledgments according to an embodiment of the present invention. The major difference between the first Co-BF frame exchange sequence and the second Co-BF frame exchange sequence is RU allocations for a first TB PPDU used to carry a BA frame 202 (which is in a TB format and solicited by the standalone trigger frame 120) and a second TB PPDU used to carry a BA frame 204 (which is in a TB format and solicited by the standalone trigger frame 122).

In this embodiment, the operating bandwidth of AP1 is 20 MHz, and the operating bandwidth of AP 2 is also 20 MHz. The BA frame (labeled by “TBBA”) 202 is contained in a payload of the first TB PPDU transmitted from STA1 to AP1. The BA frame (labeled by “TBBA”) 204 is contained in a payload of the second TB PPDU transmitted from STA2 to AP2. Regarding the embodiment shown in FIG. 2, the preamble of the first TB PPDU (which carries BA frame 202) is located on overlapping RUs within the 20 MHz operating bandwidth of AP1 and AP2, the payload of the first TB PPDU (which carries BA frame 202) is located on non-overlapping RUs within the 20 MHz operating bandwidth of AP1 and AP2, the preamble of the second TB PPDU (which carries BA frame 204) is located on overlapping RUs within the 20 MHz operating bandwidth of AP1 and AP2, and the payload of the second TB PPDU (which carries BA frame 204) is located on non-overlapping RUs within the 20 MHz operating bandwidth of AP1 and AP2. For example, the preamble of the first TB PPDU (which carries BA frame 202) and the preamble of the second TB PPDU (which carries BA frame 204) are transmitted on the same 20 MHz channel, the payload of the first TB PPDU (which carries BA frame 202) is transmitted on a 10 MHz high channel, and the payload of the second TB PPDU (which carries BA frame 204) is transmitted on a 10 MHz low channel. Specifically, the preamble of the first TB PPDU (which carries BA frame 202) is located on RUs occupied by the preamble of the second TB PPDU (which carries BA frame 204), and the payload of the first TB PPDU (which carries BA frame 202) is located on RUs not occupied by the payload of the second TB PPDU (which carries BA frame 204).

Regarding the embodiments shown in FIG. 1 and FIG. 2, the BA frames 124 and 126 (or BA frames 202 and 204) are solicited by the standalone trigger frames (e.g., MU-BAR frames), respectively. However, this is for illustrative purposes only, and is not meant to be a limitation of the present invention.

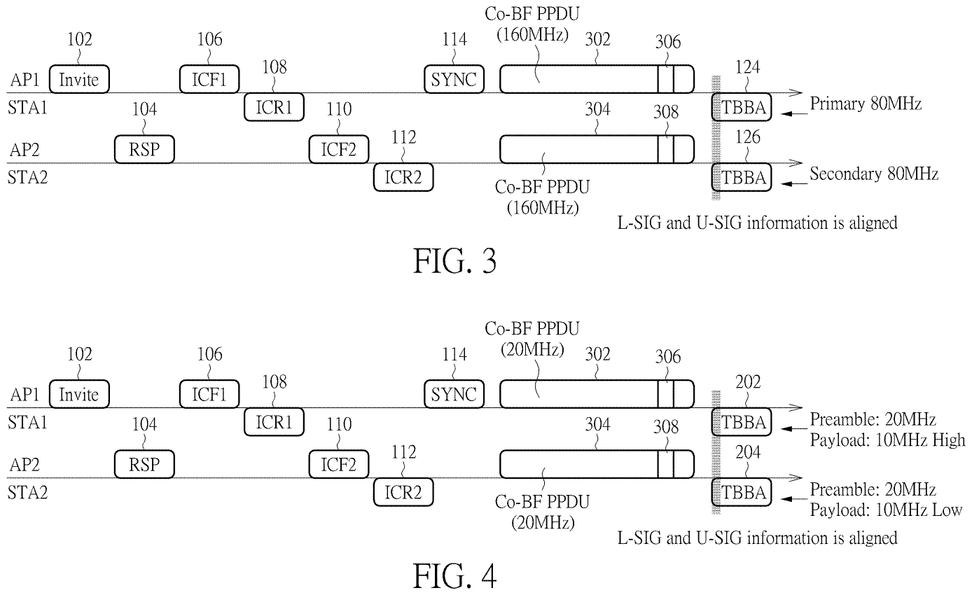

FIG. 3 is a diagram illustrating a third Co-BF frame exchange sequence with concurrent trigger-based block acknowledgments according to an embodiment of the present invention. The major difference between the first Co-BF frame exchange sequence and the third Co-BF frame exchange sequence is that standalone trigger frames (e.g., MU-BAR frames) 120 and 122 are replaced by trigger frames 306 and 308, respectively. In this embodiment, AP1 performs Co-BF transmission to transmit a DL PPDU 302 to STA1, and AP2 performs Co-BF transmission to transmit a DL PPDU 304 to STA2. Specifically, two DL PPDUs 302 and 304 are transmitted simultaneously by AP1 and AP2. The trigger frame 306 is aggregated in an aggregate media access control protocol data unit (A-MPDU) carried by the DL PPDU 302, where the A-MPDU further includes one or more data frames. The trigger frame 308 is aggregated in an A-MPDU carried by the DL PPDU 304, where the A-MPDU further includes one or more data frames.

FIG. 4 is a diagram illustrating a fourth Co-BF frame exchange sequence with concurrent trigger-based block acknowledgments according to an embodiment of the present invention. The major difference between the second Co-BF frame exchange sequence and the fourth Co-BF frame exchange sequence is that standalone trigger frames (e.g., MU-BAR frames) 120 and 122 are replaced by trigger frames 306 and 308, respectively. In this embodiment, AP1 performs Co-BF transmission to transmit a DL PPDU 302 to STA1, and AP2 performs Co-BF transmission to transmit a DL PPDU 304 to STA2. Specifically, two DL PPDUs 302 and 304 are transmitted simultaneously by AP1 and AP2. The trigger frame 306 is aggregated in an A-MPDU carried by the DL PPDU 302, where the A-MPDU further includes one or more data frames. The trigger frame 308 is aggregated in an A-MPDU carried by the DL PPDU 304, where the A-MPDU further includes one or more data frames.

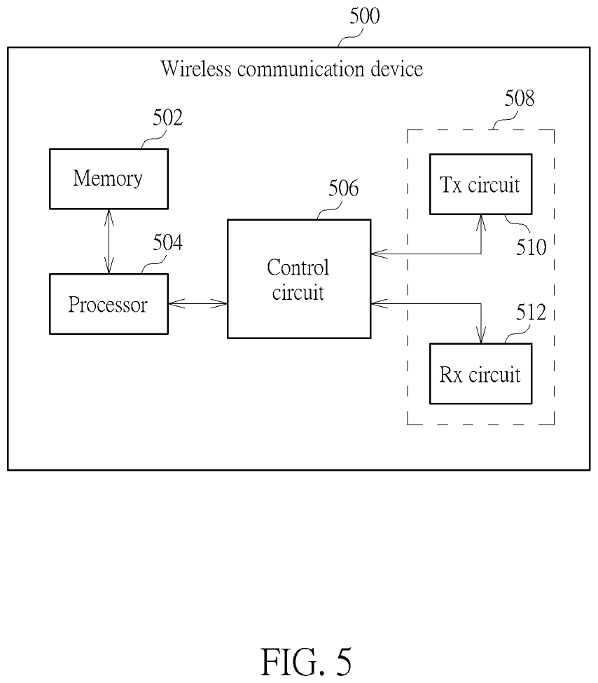

FIG. 5 is a diagram illustrating a wireless communication device according to an embodiment of the present invention. The wireless communication device 500 may be a WLAN device such as a Wi-Fi device being an AP or a non-AP STA. As shown in FIG. 5, the wireless communication device 500 includes a memory 502, a processor 504, a control circuit 506, and a network interface circuit 508, where the network interface circuit 508 includes a transmit (TX) circuit 510 and a receive (RX) circuit 512. The memory 502 is configured to store a program code. The processor 504 is configured to load and execute the program code to manage operations of the wireless communication device 500. The control circuit 506 is configured to control wireless communications with another wireless communication device (e.g., AP or non-AP STA). The wireless communication device 500 supports the proposed Co-BF frame exchange sequence shown in any of FIG. 1-FIG. 4.

In a case where the wireless communication device 500 is a Co-BF coordinating AP (e.g., AP1 shown in FIG. 1-FIG. 4), the control circuit 506 instructs the network interface circuit 508 (particularly, TX circuit 510 of network interface circuit 508) to transmit MAC frames 102, 106, 114, 120 and DL PPDU 116 (or MAC frames 102, 106, 114 and DL PPDU 302), and instructs the network interface circuit 508 (particularly, RX circuit 512 of network interface circuit 508) to receive MAC frames 104, 108, 124 (or MAC frames 104, 108, 202).

In a case where the wireless communication device 500 is a Co-BF coordinated AP (e.g., AP2 shown in FIG. 1-FIG. 4), the control circuit 506 instructs the network interface circuit 508 (particularly, TX circuit 510 of network interface circuit 508) to transmit MAC frames 104, 110, 122 and DL PPDU 118 (or MAC frames 104, 110 and DL PPDU 304), and instructs the network interface circuit 508 (particularly, RX circuit 512 of network interface circuit 508) to receive MAC frames 102, 112, 126 (or MAC frames 102, 112, 204).

In a case where the wireless communication device 500 is a recipient STA (e.g., STA1 shown in FIG. 1-FIG. 4) of the Co-BF transmission that is associated with the Co-BF coordinating AP (e.g., AP1 shown in FIG. 1-FIG. 4), the control circuit 506 instructs the network interface circuit 508 (particularly, TX circuit 510 of network interface circuit 508) to transmit MAC frames 108, 124 (or MAC frames 108, 202), and instructs the network interface circuit 508 (particularly, RX circuit 512 of network interface circuit 508) to receive MAC frames 106, 120 and DL PPDU 116 (or MAC frame 106 and DL PPDU 302).

In a case where the wireless communication device 500 is a recipient STA (e.g., STA2 shown in FIG. 1-FIG. 4) of the Co-BF transmission that is associated with the Co-BF coordinated AP (e.g., AP2 shown in FIG. 1-FIG. 4), the control circuit 506 instructs the network interface circuit 508 (particularly, TX circuit 510 of network interface circuit 508) to transmit MAC frames 112, 126 (or MAC frames 112, 204), and instructs the network interface circuit 508 (particularly, RX circuit 512 of network interface circuit 508) to receive MAC frames 110, 122 and DL PPDU 118 (or MAC frame 110 and DL PPDU 304).

It should be noted that only components pertinent to the present invention are illustrated in FIG. 5. In practice, the wireless communication device 500 may include additional components to achieve designated functions.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A wireless communication method comprising:
performing a coordinated beamforming (Co-BF) transmission to transmit a first physical layer protocol data unit (PPDU) to a first non-access point (non-AP) station (STA) associated with a first access point (AP); and
receiving a first block ack (BA) frame in a trigger-based (TB) format from the first non-AP STA, wherein the first BA frame carries information indicative of acknowledgement of the first PPDU; a period in which the first BA frame is transmitted overlaps a period in which a second BA frame is transmitted, where the second BA frame carries information indicative of acknowledgement of a second PPDU transmitted to a second non-AP STA associated with a second AP; and the first AP and the second AP comprise a Co-BF coordinating AP and a Co-BF coordinated AP.

2. The wireless communication method of claim 1, further comprising:
transmitting a trigger frame to the first non-AP STA, wherein the first BA frame is solicited by the trigger frame.

3. The wireless communication method of claim 2, wherein the trigger frame is a standalone multi-user block ack request (MU-BAR) frame.

4. The wireless communication method of claim 2, wherein the trigger frame is aggregated in an aggregate media access control protocol data unit (A-MPDU) carried by the first PPDU.

5. The wireless communication method of claim 1, wherein the first BA frame is contained in a payload of a first TB PPDU, the second BA frame is contained in a payload of a second TB PPDU, a preamble of the first TB PPDU is located on resource units (RUs) occupied by a preamble of the second TB PPDU, and the payload of the first TB PPDU is located on RUs not occupied by the payload of the second TB PPDU.

6. The wireless communication method of claim 1, wherein the first BA frame is contained in a payload of a first TB PPDU, the second BA frame is contained in a payload of a second TB PPDU, a preamble of the first TB PPDU is located on resource units (RUs) not occupied by a preamble of the second TB PPDU, and the payload of the first TB PPDU is located on RUs not occupied by the payload of the second TB PPDU.

7. The wireless communication method of claim 1, wherein the first BA frame is contained in a payload of a first TB PPDU, the second BA frame is contained in a payload of a second TB PPDU, signal (SIG) information contained in a preamble of the first TB PPDU is aligned with SIG information contained in a preamble of the second TB PPDU.

8. The wireless communication method of claim 7, wherein the first AP is the Co-BF coordinating AP, and the wireless communication method further comprises:
transmitting a Co-BF trigger frame to the second AP before the first PPDU and the second PPDU are transmitted, wherein the SIG information is solely decided by the Co-BF coordinating AP and carried by the Co-BF trigger frame.

9. The wireless communication method of claim 7, wherein the SIG information is negotiated between the first AP and the second AP before the first PPDU and the second PPDU are transmitted.

10. A wireless communication method comprising:
receiving a first physical layer protocol data unit (PPDU) from a first access point (AP) that performs a coordinated beamforming (Co-BF) transmission to a first non-AP station (STA) associated with the first AP; and
transmitting a first block ack (BA) frame in a trigger-based (TB) format to the first AP, wherein the first BA frame carries information indicative of acknowledgement of the first PPDU; a period in which the first BA frame is transmitted overlaps a period in which a second BA frame is transmitted, where the second BA frame carries information indicative of acknowledgement of a second PPDU transmitted to a second non-AP STA associated with a second AP; and the first AP and the second AP comprise a Co-BF coordinating AP and a Co-BF coordinated AP.

11. The wireless communication method of claim 10, further comprising:
receiving a trigger frame from the first AP, wherein the first BA frame is solicited by the trigger frame.

12. The wireless communication method of claim 11, wherein the trigger frame is a standalone multi-user block ack request (MU-BAR) frame.

13. The wireless communication method of claim 11, wherein the trigger frame is aggregated in an aggregate media access control protocol data unit (A-MPDU) carried by the first PPDU.

14. The wireless communication method of claim 10, wherein the first BA frame is contained in a payload of a first TB PPDU, the second BA frame is contained in a payload of a second TB PPDU, a preamble of the first TB PPDU is located on resource units (RUs) occupied by a preamble of the second TB PPDU, and the payload of the first TB PPDU is located on RUs not occupied by the payload of the second TB PPDU.

15. The wireless communication method of claim 10, wherein the first BA frame is contained in a payload of a first TB PPDU, the second BA frame is contained in a payload of a second TB PPDU, a preamble of the first TB PPDU is located on resource units (RUs) not occupied by a preamble of the second TB PPDU, and the payload of the first TB PPDU is located on RUs not occupied by the payload of the second TB PPDU.

16. The wireless communication method of claim 10, wherein the first BA frame is contained in a payload of a first TB PPDU, the second BA frame is contained in a payload of a second TB PPDU, signal (SIG) information contained in a preamble of the first TB PPDU is aligned with SIG information contained in a preamble of the second TB PPDU.

17. The wireless communication method of claim 16, wherein the SIG information is solely decided by the Co-BF coordinating AP before the first PPDU and the second PPDU are transmitted.

18. The wireless communication method of claim 16, wherein the SIG information is negotiated between the first AP and the second AP before the first PPDU and the second PPDU are transmitted.

19. An access point (AP) comprising:
a network interface circuit; and
a control circuit, configured to instruct the network interface circuit to:
perform a coordinated beamforming (Co-BF) transmission to transmit a first physical layer protocol data unit (PPDU) to a first non-access point (non-AP) station (STA) associated with the AP; and
receive a first block ack (BA) frame in a trigger-based (TB) format from the first non-AP STA;
wherein the first BA frame carries information indicative of acknowledgement of the first PPDU; a period in which the first BA frame is transmitted overlaps a period in which a second BA frame is transmitted, where the second BA frame carries information indicative of acknowledgement of a second PPDU transmitted to a second non-AP STA associated with another AP; and the AP and the another AP comprise a Co-BF coordinating AP and a Co-BF coordinated AP.

20. The AP of claim 19, wherein the control circuit is further configured to instruct the network interface circuit to transmit a trigger frame to the first non-AP STA, where the first BA frame is solicited by the trigger frame.
